(19) United States
(12) Patent Application Publication
(10) Pub. No.: US 2011/0035351 A1
(43) Pub. Date: Feb. 10, 2011

(54) SYSTEM AND A METHOD FOR AN ONLINE KNOWLEDGE SHARING COMMUNITY

(75) Inventor: Eyal Levy, Tel Aviv (IL)

Correspondence Address: Eyal Levy, Rekanati 9, Tel Aviv, 69494, omitted

(73) Assignee: Eyal Levy, Tel Aviv (IL)

(21) Appl. No.: 12/537,369

(22) Filed: Aug. 7, 2009

(51) Int. Cl. G06N 7/02

(52) U.S. Cl. 706/52

(57) ABSTRACT

A method for an online community, wherein the community members share their knowledge fields, together, thereby forming a collective knowledge pool which can be browsed and searched through by members and non-member online knowledge seekers and instantly connecting between people and groups wishing to share knowledge. The method includes subscribing by a plurality of browsers to a proprietary Website having a knowledge center server, the subscribers thereby becoming knowledge providing (client) members, providing an applicable client software program to each of the members and making online knowledge providers accessible through searching and browsing the collective knowledge pool. The method also includes the server maintaining each of the member's online/offline status indication, a knowledge seeker clicking when a relevantly knowledgeable member is online and thereby connecting with this live person to access his knowledge by online chat or other means. The connecting is through the server.

### FIELD OF THE INVENTION

The present invention relates generally to Internet communities, and more particularly, to a system and a method for an online human-knowledge community, with abilities to instantly connect, based on a knowledge tree order (index), which enables forming a search engine and browsing capability for online knowledge.

### BACKGROUND OF THE INVENTION

The Internet has many uses. One of the most common uses is finding information, mainly through public Internet search engines. These search engines often return many results to one query, sometimes forcing the user to go over many outdated or irrelevant web pages before finding the needed information.

Furthermore, today's search engines fail to lookup one of the most important Internet resources: At any given time, there are millions of people using the internet; Each and everyone of us knows something and together we know a whole lot—why go through many Internet text pages and articles, when you can instantly chat with a human being having actual knowledge in the field?

U.S. Pat. Applic. No. 20070130339, Internet-Based Education Support System and Methods, describes a system and methods for implementing education online by providing institutions with the means for allowing the creation of courses to be taken by students online, the courses including assignments, announcements, course materials, chat and whiteboard facilities, and the like, all of which are available to the students over a network such as the Internet. Various levels of functionality are provided through a three-tiered licensing program that suits the needs of the institution offering the program.

Thus, it would be advantageous for our collective human knowledge, maybe the most valuable resource on earth, to be made more easily accessible, to provide means which enable simple searching capabilities, browsing capabilities and studying through immediate online conversations.

### SUMMARY OF THE INVENTION

Accordingly, it is a principal object of the present invention to provide an online community, enabled to instantly connect, such as with Instant Messaging (IM), based on a knowledge tree order (index), which enables forming a search engine and browsing capability for online knowledge.

It is yet another principal object of the present invention to provide a means of access to browse the collective knowledge tree.

It is still another principal object of the present invention to provide the system with a “designated client,” as described herein, as well as the option of using a regular Web browser for building a full client.

It is still one other principal object of the present invention to enable “ask group”; the ability to send an online question to any knowledge group.

A method for an online community is disclosed, wherein the community members share at least one of their knowledge fields, together forming a collective knowledge pool which can be browsed and searched through by members and non-member online knowledge seekers, instantly connecting between people and groups wishing to share knowledge. The method includes subscribing by a plurality of browsers to a proprietary Website having a knowledge center server, the subscribers thereby becoming knowledge providing (client) members, providing an applicable client software program to each of the members and making online knowledge providers accessible through searching and browsing the collective knowledge pool.

The method also includes maintaining by the knowledge center server of each of the member's online/offline status indication, clicking by a knowledge seeker when a relevantly knowledgeable member is online and thereby connecting with the relevantly knowledgeable member (a live person) to access his knowledge by online chat or other means, wherein the connecting is through the knowledge center server.

The present invention provides a new approach to online knowledge finding.

The idea is to create an online shared knowledge pool, where any person can post his/her knowledge to the shared pool. Then, by enabling powerful searching and browsing tools, this live knowledge pool becomes accessible to the community and to the public.

Upon finding an available knowledgeable person or group, the present invention enables direct and immediate online contact with the knowledgeable party.

### Features of the Present Invention Include:

1. a server holding a structured knowledge tree of the members' knowledge fields
2. the server also maintains member online/offline status indication
3. if a member is online, a simple click connects the knowledge seeker (which may be a member or an anonymous surfer through the Website), with the person sharing his knowledge.
4. results can be filtered by country of origin
5. questions could be addressed online to an online knowledge group
6. the “teaching” member has the option to save and publish his chats
7. the community holds members' feedbacks on chats/knowledge, and presents this data while browsing/searching for knowledge. I.e., each member has a credibility score and indication of how many times this member actually helped someone.

The present invention makes results available by browsing “the knowledge tree.” Results are also available through a public search engine, such as Google.

Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic illustration of a system block diagram, constructed in accordance with the principles of the present invention;

FIG. 2 is an exemplary login screen, constructed in accordance with the principles of the present invention;

FIG. 3 is an exemplary search screen, constructed in accordance with the principles of the present invention;

FIG. 4 is an exemplary recorded chats browsing screen, constructed in accordance with the principles of the present invention;

FIGS. 5a, 5b, 6a and 6b are exemplary knowledge tree browsing screens, constructed in accordance with the principles of the present invention; and

FIG. 6c is an exemplary browse knowledge tree by country screen, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

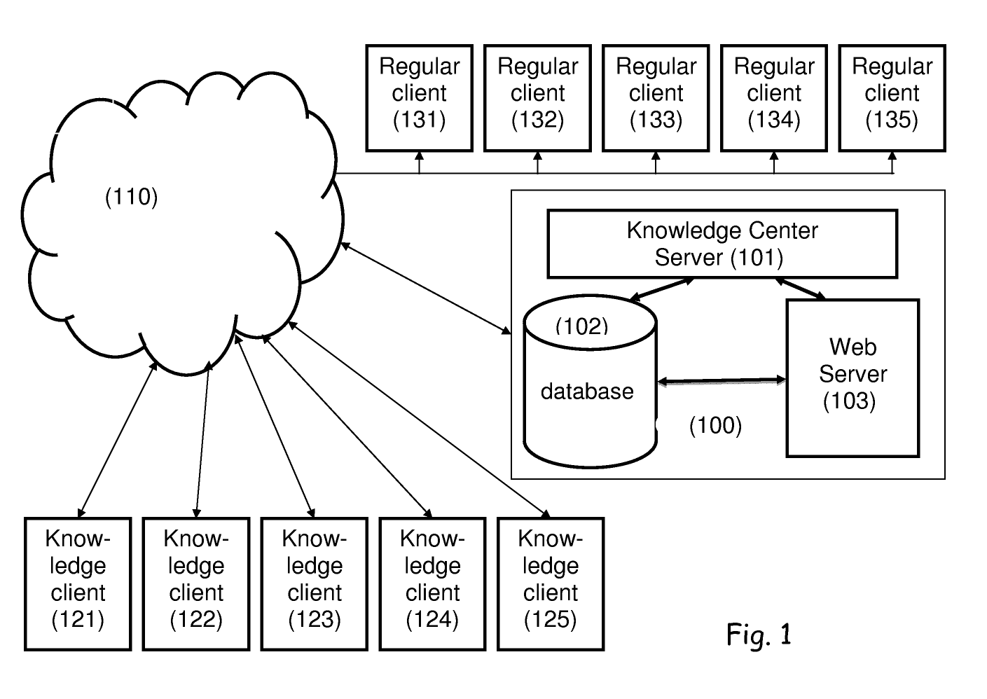

FIG. 1 is a schematic illustration of a system block diagram, constructed in accordance with the principles of the present invention. The knowledge center Website 100 includes the Knowledge center server 101, which provides connections to the members 121-125; a database 102, which holds all data on members 121-125; and a Web server 103, which connects to the community data, by connecting to the database 102.

The knowledge clients 121-125 are members who provide online knowledge. Regular www clients 131-135 connect to the Web server 103 for connecting to members 121-125 through Knowledge center server 101 and database 102.

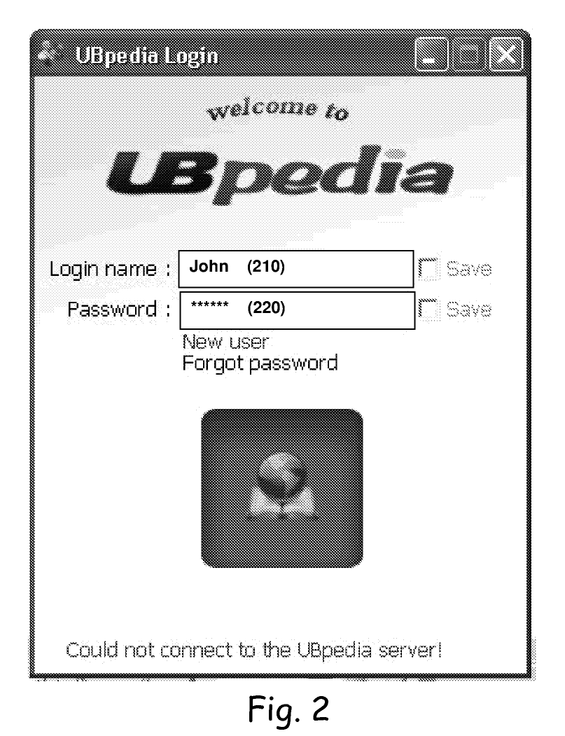

FIG. 2 is an exemplary knowledge client login screen, constructed in accordance with the principles of the present invention. The knowledge client is required for sharing your own knowledge and for the online notification of a communication request.

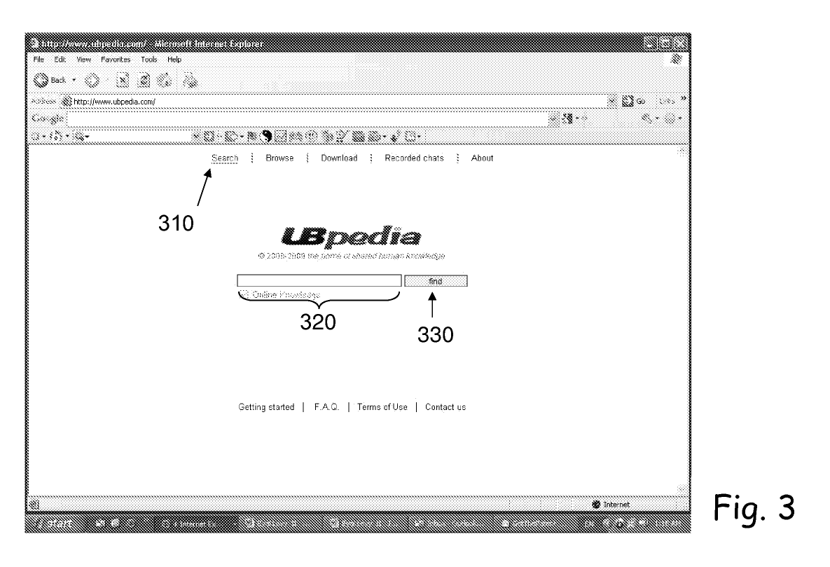

FIG. 3 is an exemplary search screen, constructed in accordance with the principles of the present invention. In search mode 310, members can enter a search term 320 and press the “find” button 330. The system will then locate and present all available online people with relevant knowledge.

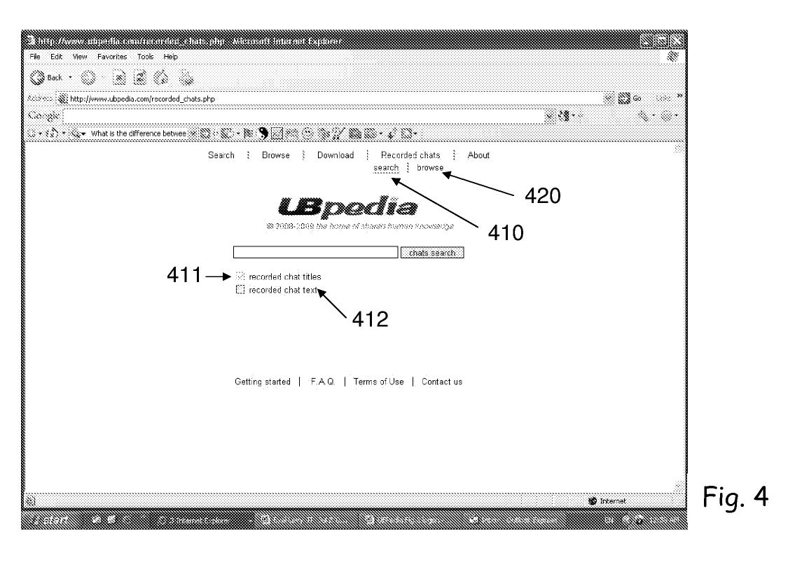

FIG. 4 is an exemplary recorded chats browse screen, constructed in accordance with the principles of the present invention. The recorded chats are previously held chats where members have answered an online question and saved the chat for public use. The answering member is the one deciding whether or not to save the chat.

When saving the chat, the member chooses the chat's title and performs basic editing for future readers to easily find the already provided solution. The users can search for a particular chat 410 or generally browse the recorded chats 420. Recorded chats can be searched by title 411 or text segment 412.

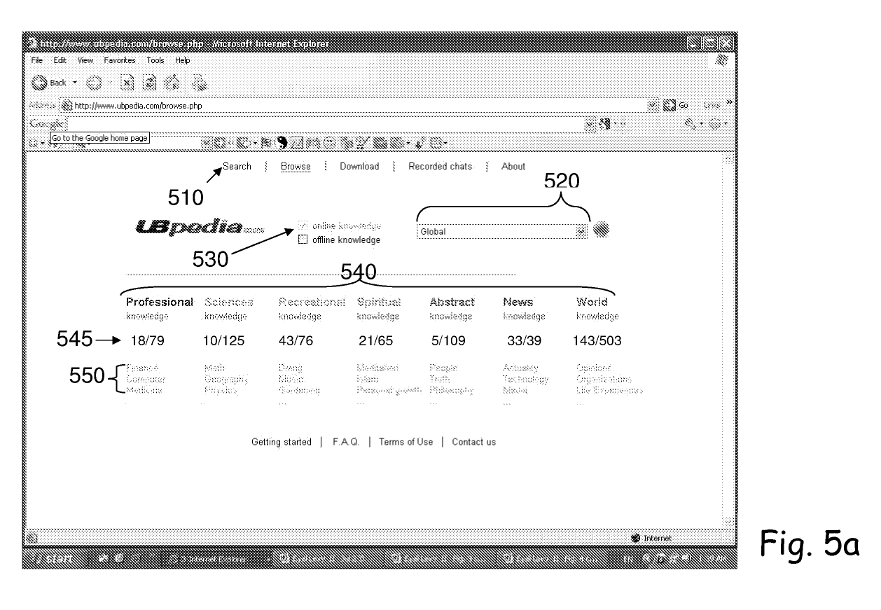

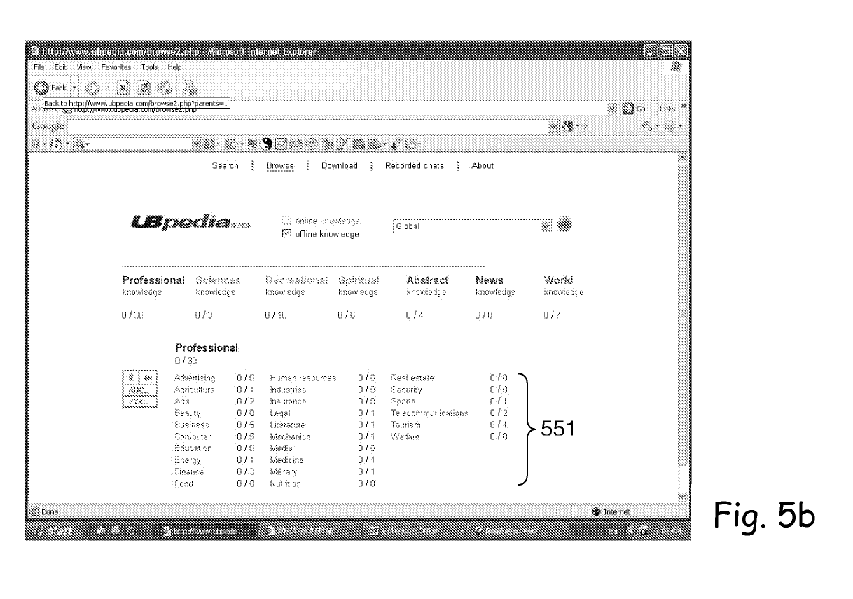

FIG. 5a is an exemplary knowledge tree browsing screen, constructed in accordance with the principles of the present invention. The user seeking knowledge may browse for online or offline knowledge 530, both in his own country, a different country or globally 520.

The knowledge tree is the logical way knowledge is arranged in the form of knowledge branches 540, starting from seven base branches: Professional, Sciences, Recreational, Spiritual, Abstract, News and World and further categorized in sub-branches 550, as needed; For example:
Professional::Food::Cooks and chefs
or
Recreational::Music::Guitar Playing::RockN'roll etc.
   This allows all knowledge fields to be presented and found easily.

The numbers 545 shown on the search and browse pages are explained as follows: When one navigate to the “search” or “browse” Web pages, the Website identifies a seeker online knowledge, and displays the current number of people online and available in the relative knowledge branch. When seeing this format: groupname (18/79), the meaning is 18 people are online out of a total of 79 registered members of the groupname knowledge branch.

FIG. 5b is an exemplary knowledge Professional offline categories screen, constructed in accordance with the principles of the present invention for registration. An expanded list of professional categories is shown 551, with the same numbering system as described with respect to FIG. 5a.

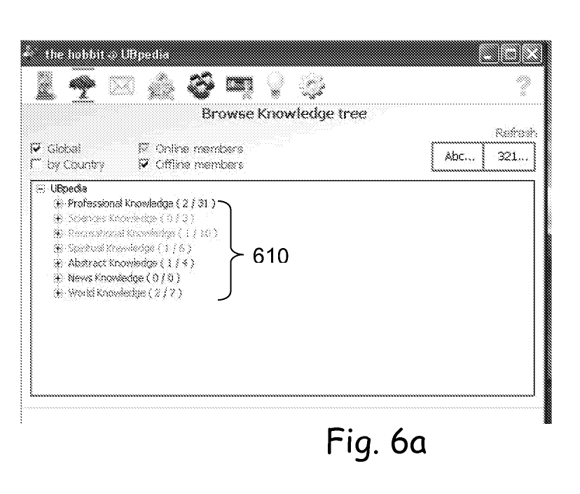

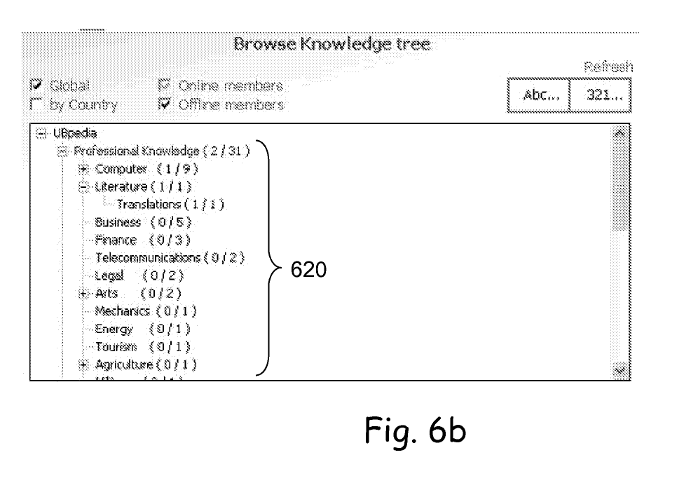

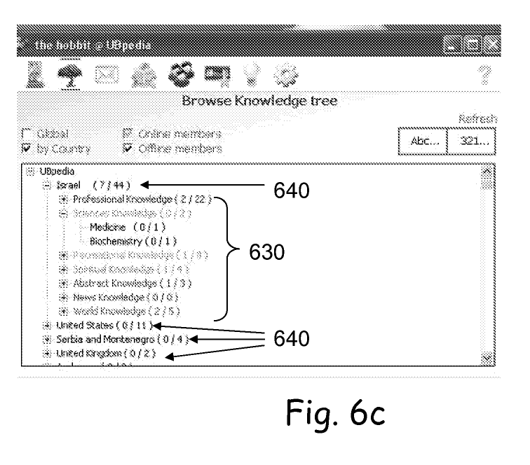

FIG. 6a is an exemplary knowledge tree screen for browsing, constructed in accordance with the principles of the present invention. Again the numbers next to the branches 610 represent the number of people online out of the total registered members of the knowledge branch, as described above with respect to FIG. 5a.

FIG. 6b is an exemplary knowledge global categories screen for browsing, constructed in accordance with the principles of the present invention. An expanded list of professional categories is shown in tree format 620, with the same numbering system as described with respect to FIG. 5a.

FIG. 6c is an exemplary knowledge tree categories screen by country for browsing, constructed in accordance with the principles of the present invention. An expanded list of professional categories 630 is shown in tree format for each country 640.

On the members pages, Levels and stars represent are shown. One of the biggest advantages in a community are the members' feedbacks. As soon as a community starts interacting, natural connections are born, and people start getting to know each other. The present invention offers a simple feedback system, in which the Level and stars are two indications of overall community feedbacks. The Level indicates the member's activity level. Each level indicated this member has helped another member one time, and can be granted once during a chat. The stars indicate the knowledge quality, which is the average score of all quality votes received by other members.

The present invention specializes in online knowledge, meaning the ability to instantly find, connect and study LIVE from a knowledgeable person available in the collective online knowledge pool. Other sites usually provide knowledge in the form of offline content (previously written articles and answers), while the focus of the present invention is online human contact. Members can also contact an online knowledge group (branch) and receive chosen news feeds.

Having described the present invention with regard to certain specific embodiments thereof, it is to be understood that the description is not meant as a limitation, since further modifications will now suggest themselves to those skilled in the art, and it is intended to cover such modifications as fall within the scope of the claims.

I claim:

1. A method for an online community, wherein the community members share at least one of their knowledge fields, together forming a collective knowledge pool which can be browsed and searched through by members and non-member online knowledge seekers, instantly connecting between people and groups wishing to share knowledge, said method comprising:
subscribing by a plurality of browsers to a proprietary Website having a knowledge center server, said subscribers thereby becoming knowledge providing (client) members;
providing an applicable client software program to each of said members;
making online knowledge providers accessible through searching and browsing the collective knowledge pool;
maintaining by said knowledge center server of each of said member's online/offline status indication;
clicking by a knowledge seeker when a relevantly knowledgeable member is online; and thereby
connecting with said relevantly knowledgeable member (a live person) to access his knowledge by online chat or other means, wherein said connecting is through said knowledge center server.

2. The method of claim 1, wherein said knowledge seeker is also a member, connecting through said Website.

3. The method of claim 1, wherein said shared knowledge is organized in a logical tree order, wherein the base of the tree has a few general knowledge categories, and further expands to sub-branches.

4. The method of claim 1, wherein said knowledge seeker is an anonymous surfer to said Website.

5. The method of claim 1, further comprising providing categorized (knowledge tree-indexed) RSS news feeds.

6. The method of claim 1, wherein said searchably accessible results can be filtered by country of origin.

7. The method of claim 1, further comprising enabling questions to be addressed online to an online and/or offline knowledge group.

8. The method of claim 1, wherein said knowledge providing (“teaching”) member has the option to save and publish his said chats.

9. The method of claim 1, wherein said members form online communities, said communities enabling members to provide feedback on other member's activities.

10. The method of claim 1, wherein the knowledge center stores said members' feedbacks on chats/knowledge in a database, and further comprising presenting this data while browsing/searching for knowledge.
